(19) United States
(12) Patent Application Publication
(10) Pub. No.: US 2004/0165074 A1
(43) Pub. Date: Aug. 26, 2004

(54) Sensor array system and method for realistic sampling

(76) Inventors: James R. Kelton, Austin, TX (US); Margaret M. Kelton, Austin, TX (US)

Correspondence Address: HULSEY, GRETHER, FORTKORT & WEBSTER, LLP, 8911 N. CAPITAL OF TEXAS HWY., SUITE 3200, AUSTIN, TX, 78759, US

(21) Appl. No.: 10/785,883

(22) Filed: Feb. 24, 2004

Related U.S. Application Data
(60) Provisional application No. 60/449,733, filed on Feb. 24, 2003.

(51) Int. Cl. H04N 5/225

(52) U.S. Cl. 348/207.99; 348/222.1

(57) ABSTRACT

A method is described which better aligns the spatially dependent resolution of a sampled image sensor to the resolution requirements of an image. Most images contain greater frequency extent in the horizontal and vertical directions and therefore can benefit from higher resolution. By rotating the sampling grid of a sampled imaging sensor relative to the sampling area it is possible to better align the spatial components of the sensor which possess the highest resolution with the components of the image with the highest frequency content.

### CROSS REFERENCE TO RELATED APPLICATIONS

This application is a continuation of application Serial No. 60/449,733, filed on Feb. 24, 2003, and entitled “Sensor Array System and Method for Realistic Sampling.”

### FIELD OF THE INVENTION

The present invention relates generally to the field of image processing and more specifically to methods for digitizing images.

### BACKGROUND OF THE INVENTION

Digital cameras have sparked much interest in electronic imaging in recent years. These cameras rely on image sensors with a large number of active elements. Each active element converts the flux of light to an electric charge. In a typical image sensor, the light flux is allowed to accumulate for a fixed amount of time producing a charge which is proportional to the light flux and the time of the exposure. The charge is then read from each active element in the sensor to form a mapping of the light intensity falling on the image sensor. To produce color images, the active elements of the image sensors are made to be sensitive to different wavelengths of light. This can be done with dyes placed on the active elements or through taking advantage of the skin depth of the silicon used in the arrays. The Bayer sensor has been the standard for color arrays and uses 1 red, 1 blue, and 2 green elements in a repeated pattern to represent color. Recently a sensor has also been introduced which captures the three primary colors on in single active element by Fovion, Inc. CCD and CMOS sensors are both in widespread use as well and represent variations on the technique outlined above. These variations in technology and methodology, while significant to various performance parameters of the image sensor, are all amenable to the invention outlined below.

Discrete time sampling of continuous time waveforms has been well understood for many years. Nyquist provided the seminal paper on the topic when he showed that a continuous time signal which is strictly bandlimited to frequencies less than W Hz can be exactly reconstructed when uniformly sampled in time at a sampling rate of at least 2/W. The sampling theorem is covered in great detail in many texts, for example see “Descrete Time Digital Signal Processing” by Oppenhiem and Shafer for a more complete discussion. An overview will be presented below to introduce terminology needed for the development of the present invention.

Nyquist's results can be understood if sampling is modeled as a multiplication of an impulse train with the continuous time bandlimited signal f(t). The impulse train is given by:

s(t)=Σδ(t−mT) m=all integers eqn. 1

The sampled signal is then given by:

fs(t)=f(t)s(t) eqn. 1

This can be represented in the frequency domain as:

Fs(w)=F(w)*S(w) eqn. 2

where (*) is the convolution operator and F(w) and S(w) are the Fourier transforms of F(w) and S(w).

The Fourier transform of a uniformly spaced impulse train is:

S(w)=Σδ(w−2 πn/T) n=all integers eqn. 3

Because this is also an impulse train, the convolution of S(w) with F(w) will produce multiple copies of F(w) centered at w=2 πn/T. Note that if the maximal frequency of F(w) is limited to less than π/T the copies of F(w) will not overlap and F(w) can be exactly recreated from Fs(w).

The one dimensional derivation of the sampling theorem can be extended to 2 dimensions. An overview will be presented below to introduce terminology. A more complete description of the two dimensional sampling theorem can be found in “Multi-Dimentional Digital Signal Processing” by Jackson. Consider the two dimensional impulse array

s(x,y)=ΣΣδ(x−mx0,y−n y0) m,n=all integers eqn. 4

As with the one dimensional sampling theorem consider a signal f(x,y) which is bandlimited to less than Wx and Wy Hz in the x and y dimensions. Sampling of the signal f(x,y) will be modeled as the multiplication in the spatial domain of f(x,y) with s(x,y) such that

fs(x,y)=f(x,y)s(x,y) eqn. 5

In the frequency domain this can be written as:

Fs(wx,wy)=F(wx,wy)*S(wx,wy) eqn. 6

where wx is the frequency component in the x direction and wy is the frequency component in the y direction. As in the one dimensional case, the Fourier transform of the impulse array gives:

S(wx,wy)=ΣΣδ(x−2 πm/x0,y−nπ/y0) m,n=all integers eqn. 7

which is another impulse array. For the common case where x0=y0, the signal f(x,y) can be exactly reconstructed from fs(x,y) if the original signal has no frequency component above π/x0. However, this condition is actually more restrictive than necessary. Along a diagonal the signal can have frequency components up to sqrt(2)*π/x0 because of the greater separation of the impulses in the impulse array S(wx,wy) along a diagonal.

The choice of s(x,y) above gives a rectangular grid. It is because s was chosen as rectangular in the spatial domain that the impulse array in the frequency domain was also rectangular. Another common chose of s(x, y) is referred to as hexagonal and results when every other row (or column) of the rectangular grid is shifted one half unit relative to the other rows as follows:

s(x,y)=ΣΣδ(x−(m+mod(n,2)/2)x0,y−n y0) m,n=all integers eqn.

The solution to the hexagonal sampling theorem is given in Jackson's book “Multi-Dimensional Digital Signal Processing.” It is shown that the hexagonal sampling in the spatial domain gives hexagonal patterns in the frequency domain as well. This pattern can extend the frequency response in the x dimension by 26% but does not extend the response in the y direction.

### BRIEF DESCRIPTION OF THE DRAWINGS

FIG. 1 is the frequency domain representation of a two dimensional signal with a maximum frequency content in the x and y directions in 0.048 cycles/mm.

FIG. 2 is a close up of rectangular sampling grid with a sample spacing of 10 mm.

FIG. 3 is a frequency domain representation of the result of sampling the signal in FIG. 1 with the rectangular grid in FIG. 2.

FIG. 4 is a close up of hexagonal sampling grid with a sample spacing of 10 mm. FIG. 5 is a frequency domain representation of the result of sampling the signal in FIG. 1 with the hexagonal grid in FIG. 4.

FIG. 6 is a close up of a diagonally rectangular sampling grid with a sample spacing of 10 mm in which the sampling grid is rotated by arctan(¾) radians.

FIG. 7 is a frequency domain representation showing the aliasing which results when the signal in FIG. 1 sampled with the diagonal rectangular grid in FIG. 6. No aliasing occurs with this sampling method. Note that with this sampling technique the signals no longer touch in either the x or y direction.

FIG. 8 is the frequency domain representation of a signal with a maximum frequency extent of 0.068 cycles/mm.

FIG. 9 is the frequency domain representation of the signal in FIG. 8 sampled with the rectangular grid in FIG. 2 showing significant aliasing.

FIG. 10 is a frequency domain representation of the signal in FIG. 8 sampled with the hexagonal grid in FIG. 4 showing aliasing.

FIG. 11 is a frequency domain representation of the signal in FIG. 8 sampled with the diagonal rectangular grid in FIG. 6 showing no aliasing.

### DETAILED DESCRIPTION OF THE INVENTION

Generally speaking images of natural and man made scenes have greater frequency response in the x and y (horizontal and vertical respectively) dimensions than along a diagonal. This is due to the predominance of edges in the x and y planes in these scenes. Hence it is desirable to have greater frequency content in the x and y dimensions than along the diagonals. Rectangular sampling accomplishes just the opposite, giving greater frequency response along the diagonals than in either the x or y directions. Hexagonal sampling improves this situation by favoring one of x or y, but not both. The present invention addresses this by introducing a type of sampling which favors the frequency response in the x and y directions at the expense of the diagonals. This better matches the needs of images of most types of scenery of interest in digital storage of images.

The basis of the present invention is to rotate the sensor arrays to some angle relative to a rectangular box which defines the area on which the sensors are located. In present sensor arrays, the sensors typically are oriented in rows and columns which run parallel to the edges of a rectangle which defines the outline of the active sensor arrays. By orienting the rows and columns of the sensors at some angle relative to this rectangle, the same rotation of the frequency response is introduced in the frequency domain. Thus the rectangular or hexagonal sampling patterns mentioned above can be used with a rotation to extend the frequency response of the sampled signal preferentially in the x and y directions.

When an image produced with such a sensor pattern is to be displayed on a display device which has a rectangular grid such as a computer monitor, the image must be interpolated to this rectangular gird. Several methods of interpolation exist and are well understood in the art to interpolate between hexagonal and rectangular sampling patterns in which the rows and columns of the sensor arrays are parallel to the edges of the sensor array. The invention further covers interpolation methods which are appropriate for interpolation between an image in which is formed with sensors not parallel to the edges of the active sensor area and rectangular grids which are parallel to the active area of the sensors.

In order to verify the functionality of the non-parellel image arrays, simulations of such arrays have been performed using the Matlab program from the Mathworks corporation. The simulations have been performed using images with a known frequency response sampled on a 500×500 array. The sampling was performed using a sample spacing of 10 samples on the array. For rectangular sampling this places samples on the intersection of all rows and columns indexed by 1+10 n, n=0 . . . 49. Using the sampling grid uniformly spaced on the 500×500 array closely approximate the effects of sampling a continuous signal on the sparse grid. This was done with rectangular and hexagonal sampling with the sampling grid parallel to the edges of the large array as well as with the sampling grid at angles to the edges of the array to demonstrate diagonal rectangular sampling. In particular, the angle of arctan(¾) is used because this angle produces samples at only integer points on the larger array. The present invention is not intended to be limited to this angle and it should be understood by one of skill in the art that this angle was chosen only for ease of simulation. The present invention is also not to be limited to diagonal representations of rectangular sampling only and diagonally heaxagonal sampling is easily realized by rotating a hexagonal sampling pattern instead of a rectangular pattern.

For the remainder of this discussion, the 500×500 array will be assumed to represent points spaced 1 mm apart without loss of generality. Therefore the sampling grids which samples spaced 10 units apart on the 500×500 array will represent sampling points spaced 1 cm apart.

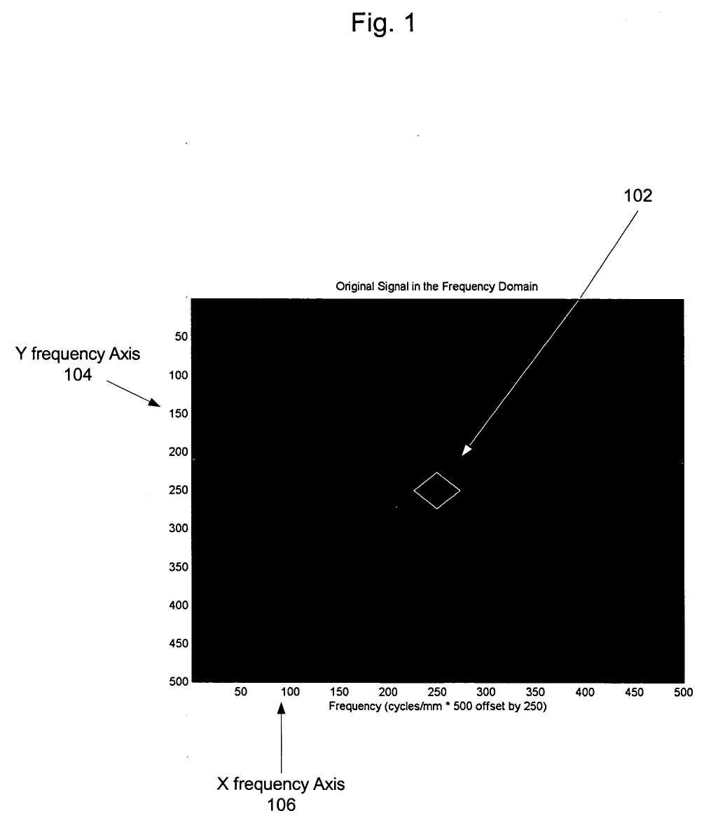

The signal used for the simulations is a diamond in the frequency domain. This is an example of a signal with higher frequency components in the x and y directions than along diagonals. This first such signal used had a maximum frequency component of 0.048 cycles/mm in the x/y directions as illustrated in FIG. 1. FIG. 1 shows the y frequency axis 106 and the x frequency axis 104 in addition to the spectrum of the signal 102. The axes 104 and 106 show the frequency in cycles per millimeter (mm) multiplied by 500 and offset by 250. Therefore the value of 250 on the axis represents zero frequency and a value of 500 represents a frequency of 0.5 cycles/mm.

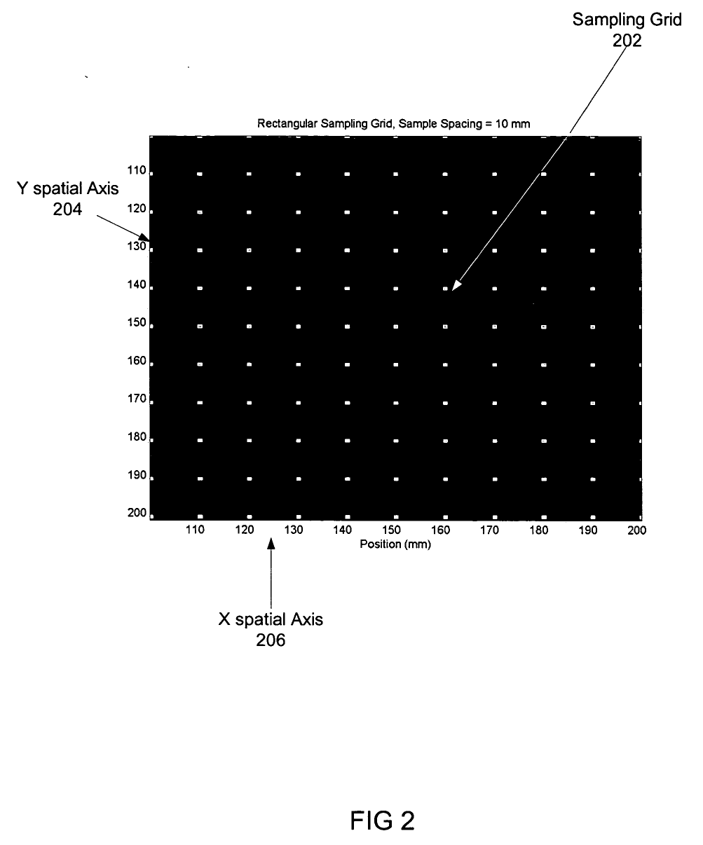

FIG. 2 illustrates a rectangular sampling grid. The figure consists of the y spatial axis 206, the x spatial axis 204, and close up of the sampling grid 202. The grid consists of uniform impulses at the intersections of every 10^{th} row and column on the 500×500 sampling area. The 500×500 square is bordered by the line segments for (0,0) to (0,500), (0,0) to (500,0), (0,500) to (500,500), and (500,0) to (500,500). This rectangle forms the sampling area. No sampling points are present outside of this rectangle. This sampling area is assumed in all representations of sampling grids in this document. The sampling grid can represent a signal with a maximum x or y frequency content of 0.05 cycles/mm.

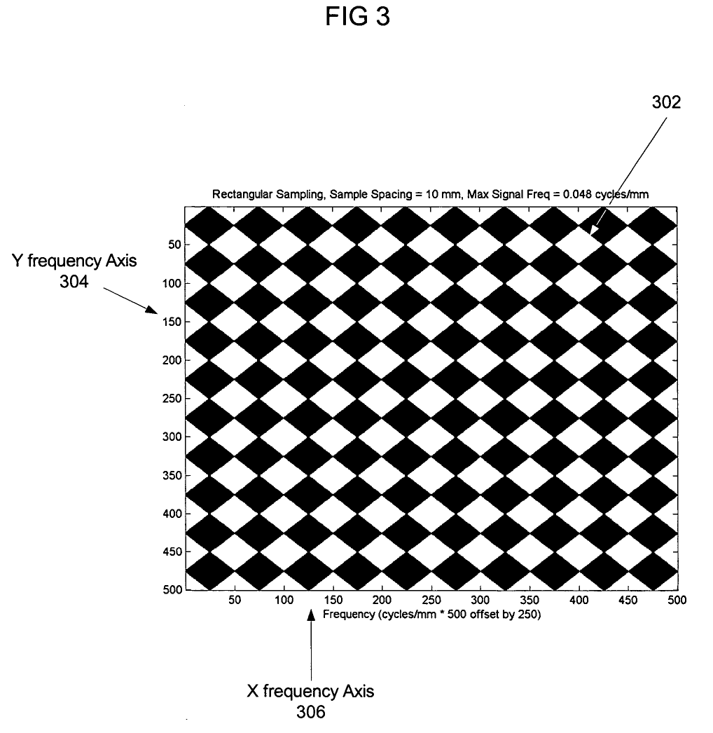

Sampling is simulated by performing a point by point multiplication of the rectangular grid shown in FIG. 2 with the inverse discrete Fourier transform of the frequency domain representation of the signal in FIG. 1. The discrete Fourier transform of the result of this point by point multiplication is then performed to yield the frequency domain representation of the sampled signal and is shown in FIG. 3. FIG. 3 contains the x frequency axis 304 and the y frequency axis 306 which are defined in the same manner as in FIG. 1 as well as the spectrum of the signal resulting from the sampling as described above. FIG. 3 shows that the signal in FIG. 1 can just be represented without any overlap of the copies of the signal created in the frequency domain by the sampling. Overlap of the copies of the signal in the frequency domain makes recovery of the original signal from the samples impossible and is referred to as aliasing. Because the copies of the original signal nearly touch, this signal can be deemed to be near the highest frequency signal of the form shown in FIG. 1 which can be represented without aliasing.

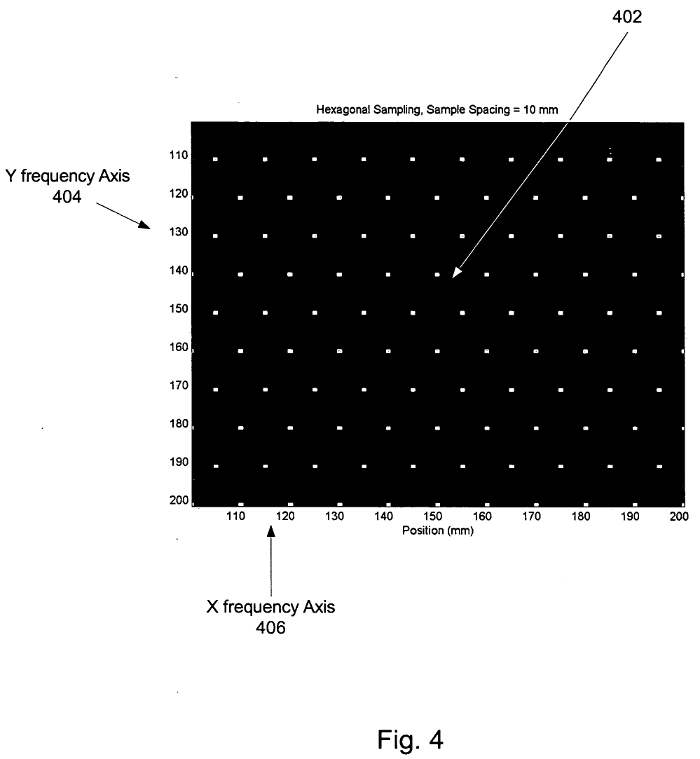

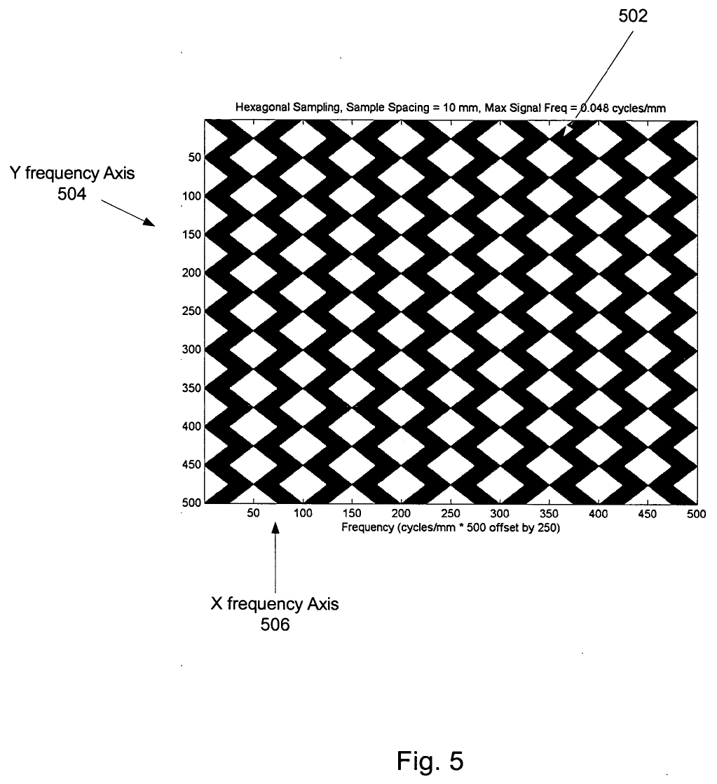

FIG. 4 shows a close up of a hexagonal sampling grid. FIG. 4 consists of the x spatial axis 404 and the y spatial axis 406 in additional to a graphical representation of the sampling grid 402. The axis are defined as in FIG. 2. This sampling grid is the same as rectangular sampling except every other row is moved by ½ sample. Since the sampling interval is 10 mm, every other row is shifted 5 mm. This sampling technique is known to increase the maximum sampling frequency in the x direction despite using no additional active elements.

Hexagonal sampling is simulated in a manner exactly analogous to the outline given above for the rectangular sampling case represented in FIG. 3 expect the sampling grid in FIG. 4 is used instead of that in FIG. 2. The results are shown in FIG. 5. FIG. 5 contains the x frequency axis 504 and the y frequency axis 506 which are defined in the same manner as in FIG. 1 as well as the spectrum of the signal 502 resulting from the sampling as described above. The copies of the signal no longer touch in the x direction due to the superior frequency representation of hexagonal sampling in this dimension. However the signals still nearly meet in the y direction and therefore this signal still represents nearly the largest frequency signal which can be reproduced faithfully with this sampling technique.

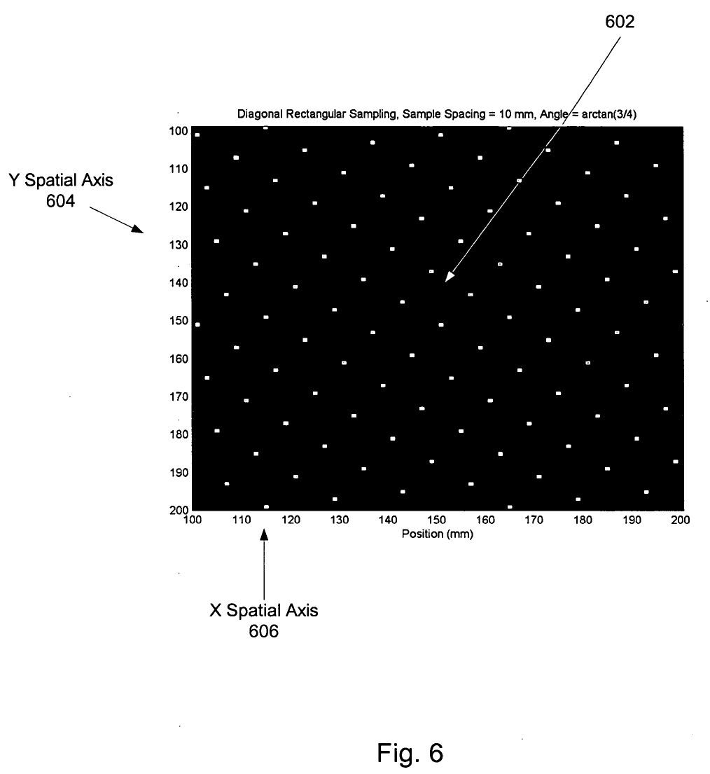

FIG. 6 shows a diagonal rectangular sampling grid. FIG. 6 contains x spatial axis 604 and y spatial axis 606 defined as in FIG. 2 and a close up of the sampling grid 602. This grid can be created by rotating an infinite rectangular grid by a fixed angle and then truncating the resulting infinite grid with a rectangle with vertices at (0,0), (0,500), (500,0), and (500,500). The same technique described above is used to simulate sampling except the sampling grid in FIG. 6 is used instead of that in FIGS. 2 and 4.

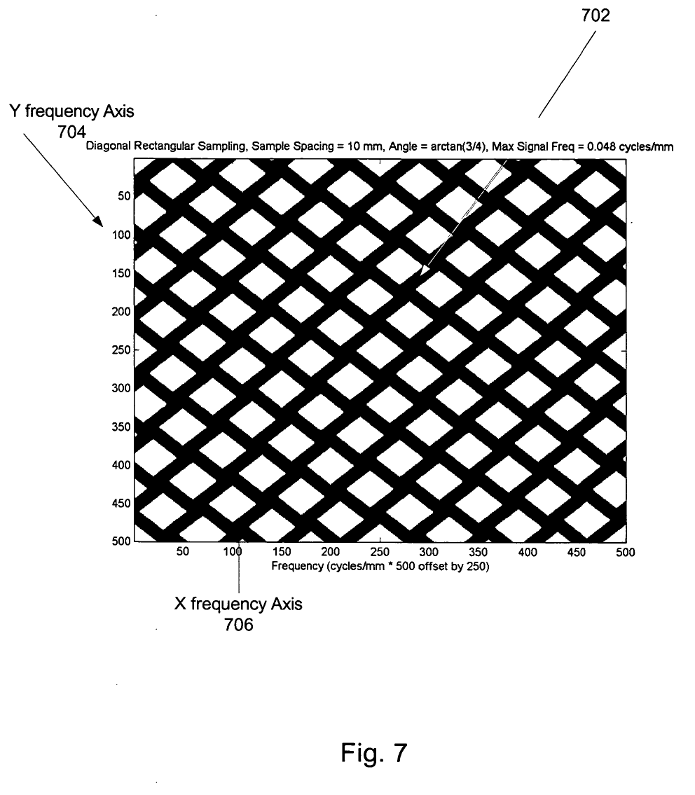

The results are shown in FIG. 7. FIG. 7 contains the x frequency axis 704 and the y frequency axis 706 which are defined in the same manner as in FIG. 1 as well as the spectrum of the signal 702 resulting from the signal in FIG. 1 using the sampling grid defined in FIG. 6. Note that the copies of the signal no longer touch in either the x or y direction indicating that a larger bandwidth signal can be represented.

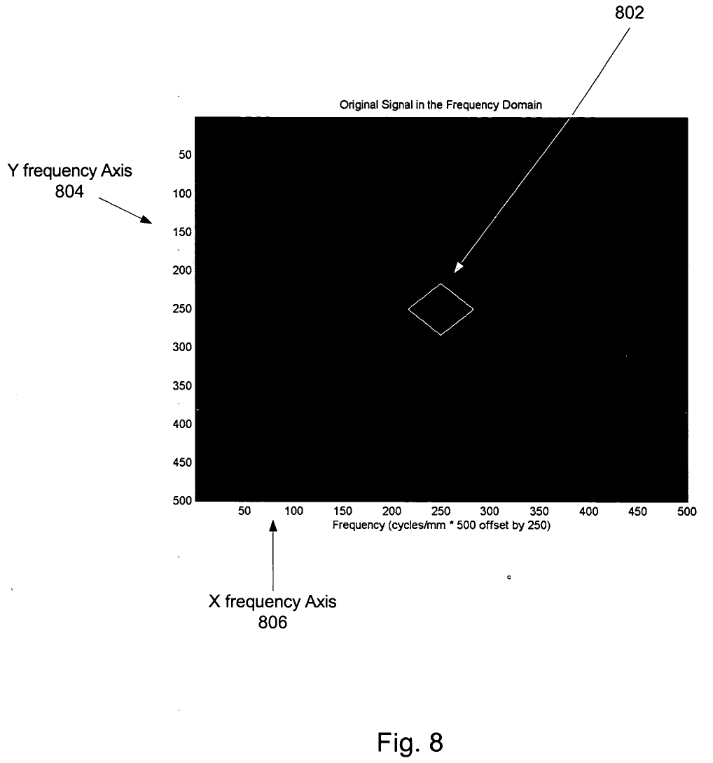

The above three sampling techniques where again simulated except this time the signal in FIG. 8 was used instead of the signal in FIG. 1. FIG. 8 contains the x frequency axis 804 and the y frequency axis 806 which are defined in the same manner as in FIG. 1 as well as the spectrum of the signal 802. These signal in FIG. 8 is identical to the signal in FIG. 1 except that the maximum frequency of the signal in FIG. 8 is 0.068 cycles/mm instead of 0.048 cycles/mm.

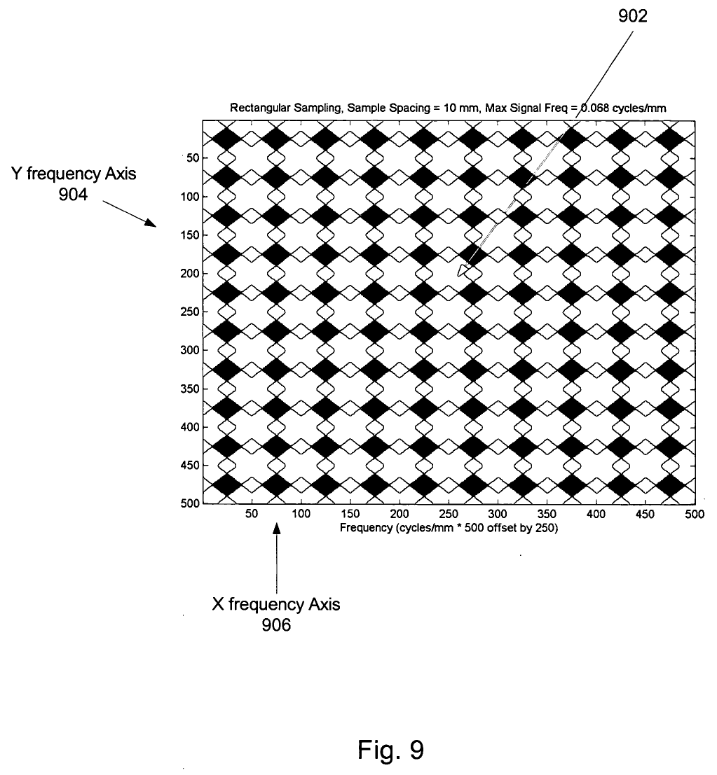

Sampling using the rectangular sampling grid in FIG. 2 results in the spectrum shown in FIG. 9. FIG. 9 contains the x frequency axis 904 and the y frequency axis 906 which are defined in the same manner as in FIG. 1 as well as the spectrum of the sampled signal 902. Note that overlap of the copies of the signals now occurs in both the x and y directions. This is to be expected as the Nyquist limit on rectangular sampling in these directions is 0.05 cycles/mm.

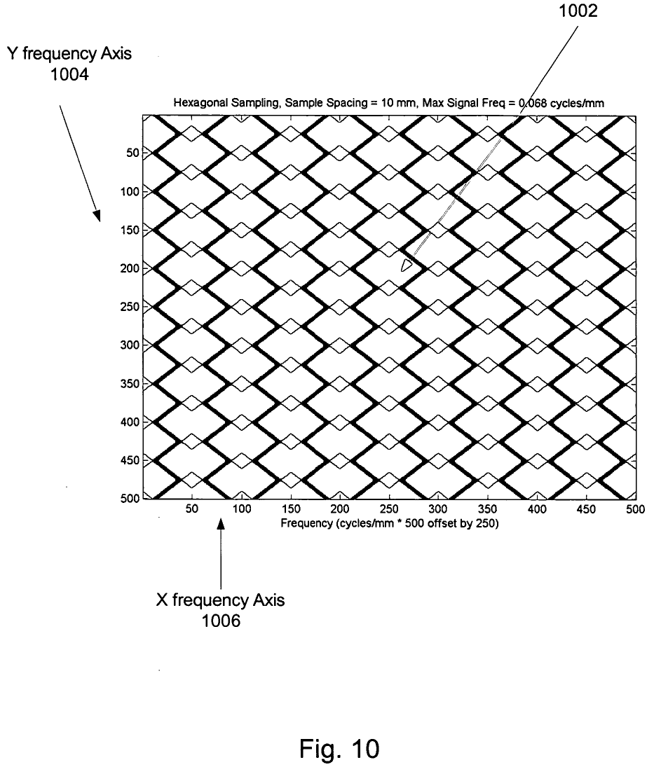

FIG. 10 shows the results when the hexagonal sampling grid in FIG. 4 is used to sample the signal in FIG. 8. FIG. 10 contains the x frequency axis 1004 and the y frequency axis 1006 which are defined in the same manner as in FIG. 1 as well as the spectrum of the signal 1002 resulting from the sampling of. The overlap is now removed in the x direction but still remains in the y direction. This aliasing will not be as severe as with rectangular sampling but will still degrade the image.

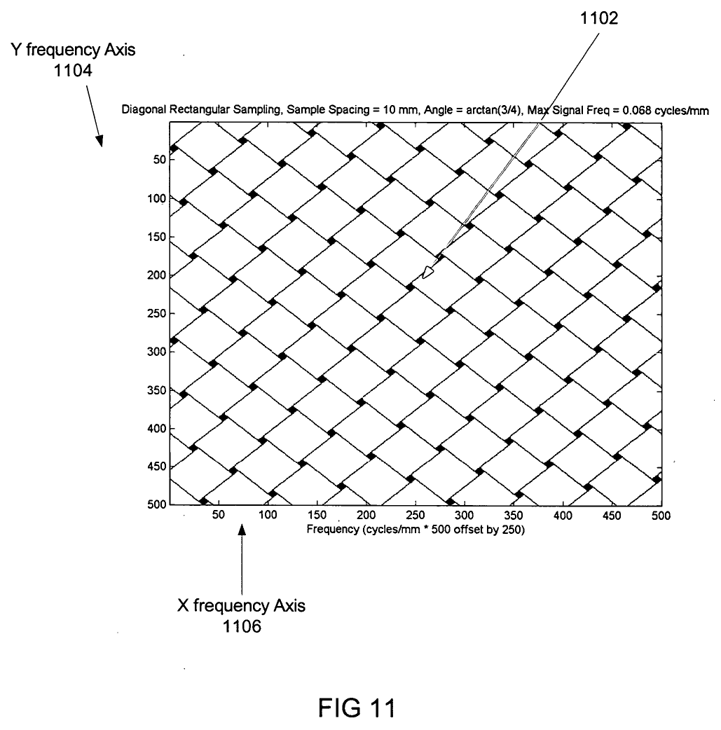

FIG. 11 shows the results of the diagonally rectangular sampling. FIG. 11 contains the x frequency axis 1104 and the y frequency axis 1106 which are defined in the same manner as in FIG. 1 as well as the spectrum of the signal 1102 which results when the signal in FIG. 8 is sampled using the sampling grid shown in FIG. 6. Note that no overlap of the copies of the spectrum are present and the image can be exactly recovered. The spatial frequency of 0.068 cycles/mm represents the highest frequency which does not alias with the diagonally rectangular sampling grid with an angle of arctan(¾) in simulation and represents an increase of the maximum frequency of a signal of the form shown in FIGS. 1 and 8 of 34%. An angle of 45 degrees would yield an increase of over 41%.

Note that no image in nature is actually bandlimited and some aliasing occurs whenever a sampled image of a natural scene is produced. Only the most contrived of manmade images will be bandlimited. The aliasing of a real image can be reduced by natural low pass filtering effects of optics, the geometry of active elements, and imperfect focus. However these filtering effects do not attenute the high frequency content of a signal sufficiently to completely avoid aliasing. However, for any signal containing higher frequency components in the x and y directions (horizontal and vertical), diagonal sampling can be used advantageously to reduce the effects of aliasing with the same number of active elements.

While the simulations presented show diagonal rectangular sampling, the technique of rotating the sampling grid to extend the frequencies which can be faithfully reproduced in the x/y directions is not limited to rectangular arrays. The same concept can be applied to hexagonal arrays. This would be accomplished by rotating a sampling grid of the form of that shown in FIG. 4 but infinite in extent by a desired angle and then truncating it with a rectangle as described above in the development of the diagonal rectangular array. The resulting diagonal hexagonal array will possess the same ability to represent the high frequency contents of signals as hexagonal sampling except that the response will be rotated by the angle of rotation of the array. Hexagonal sampling is known to produce a hexagonal pattern in the frequency domain which can be faithfully reproduced. However, this hexagon is oriented to give maximum advantage in the x direction and no advantage in the y direction for the array shown in FIG. 4. By rotating the sampling grid some of the advantage can be moved to the y direction at the expense of the x direction. Rotations of 15 or 45 degrees (or any 60 degree increment beyond this from symmetry) will equalize the max frequencies which can be represented in the x and y directions and in both cases will increase this maximum frequency beyond what can be accomplished with rectangular sampling.

In order to display a signal sampled with any diagonal technique on a display device with rectangular spaced samples, the signal must be interpolated. Many types of interpolation will transfer an image sampled on a diagonal grid to be accurately represented on a rectangular grid. The simplest form of interpolation is to simply transfer the nearest point on the diagonal grid onto a given point on the desired rectangular grid. This is very simple but does not yield good results. The next step is to use a linear weighting of several of the nearest points on the diagonally sampled image onto the rectangular grid. The weighting can be as simple as an inverse distance weighting in which the distance from, for example, each of the four nearest neighbors is determined and the weighting of each of these points is determined as the normalized inverse of the distance from the rectangular point to the diagonally sampled points. This method is computationally trackable and produces results which can have acceptable quality. Many other forms of interpolation are given in the literature and a complete summary of all these methods is beyond the scope of this invention.

The following is the Matlab code which generates the simulations described above.

%Create a approximation to sampling with rectangular, hexagonal, and
diagonal-rectangular
% sampling grid. Create a diamond shaped frequency content signal at
high resolution (500×500) and sample
% with each of the three sampling grids. Display frequency domain
results. Assume with loss of generality
% that 500×500 array places samples every 1 mm. This gives a Nyquist
frequency for rectangular sampling of 1/2
% cycle/mm. This will be respresented at sample 250 of the diplays.
Then a sample spacing of 10 represents
% a sample every 1 cm. The rectangular sampling grid should therefore
show aliasing at a frequency 1/20 cycle/mm
% which will be represented by sample 25 on the 500×500 display. The
maximum single sided bandwidth of the
% signal in the x and y directions is given by r. Setting r = 25 will
show the beginning of aliasing in the
% rectangular (and hexagonal) sampling grids.

| | |
|---|---|
| N = 500/2; | %Set high resolution grid to 500×500 |
| sample_spacing = 10; | %Set sample spacing to 10 time domain units |
| index = 0; | %Create sampling grid for diagonal/rectangular |
| grid | |
| for kk = 1:N | |

diags(kk,:) = kron(ones(1,10),[zeros(1,index) 1 zeros(1,24−index)]);
index = mod(index−7,25);
end
diags_rect = kron(diags,[1 0;0 0]);

| | |
|---|---|
| rect = ones(50,50); | %Create rectangular grid |
| temp = zeros(10,10); | |
| temp(1,1) = 1; | |
| rect = kron(rect, temp); | |
| hex = zeros(20,10); | %Create hexagonal grid |
| hex(1,1) = 1; | |
| hex(11,6) = 1; | |
| temp = ones(25,50); | |
| hex = kron(temp,hex); | |
| clear array; | |

| | |
|---|---|
| array=zeros(500,500); | %Set up signal array at 500×500 resolution |
| r=34; | %Set max one sided freq extent of signal |
| centx = 250; | %Center signal in frequency domain |
| centy = 250; | |
| dones | |

| | |
|---|---|
| signal = ifft2(array); | %Create spacial domain signal |

rect_diag_samp_signal = signal.*diags_rect; %Sample signal using
diagonal hexagonal sampling
rect_diag_samp_signal_fd = fft2(rect_diag_samp_signal);

| | |
|---|---|
| rect_samp_signal = signal.*rect; | %Sample signal using |
| rectangular sampling | |

rect_samp_signal_fd = fft2(rect_samp_signal);
hex_fd = fft2(hex);

| | |
|---|---|
| hex_samp_signal = signal.*hex; | %Sample signal using |

hexagonal sampling
hex_samp_signal_fd = fft2(hex_samp_signal);
double image_disp;
image_disp(500,500,3) = 0;
figure(1)
image_disp(:,:,1) = abs(rect_samp_signal_fd)/
max2(rect_samp_signal_fd);
image_disp(:,:,2) = image_disp(:,:,1);
image_disp(:,:,3) = image_disp(:,:,1);
image(image_disp);
title_{—} = [‘Rectangular Sampling, Sample Spacing = 10 mm, Max Signal
Freq = ‘,num2str(r/500),’ cycles/mm’];
Title(title_)
xlabel(‘Frequency (cycles/mm * 500 offset by 250)’)
file_{—} = [‘rect_fd_’,num2str(r)];
print(‘-djpeg’,file_);
figure(2)
image_disp(:,:,1) = abs(hex_samp_signal_fd)/
max2(hex_samp_signal_fd);
image_disp(:,:,2) = image_disp(:,:,1);
image_disp(:,:,3) = image_disp(:,:,1);
image(image_disp);
title_{—} = [‘Hexagonal Sampling, Sample Spacing = 10 mm,
Max Signal Freq
= ‘,num2str(r/500),’ cycles/mm’];
Title(title_)
xlabel(‘Frequency (cycles/mm * 500 offset by 250)’)
file_{—} = [‘hex_fd_’,num2str(r)];
print(‘-djpeg’,file_);
figure(3)
image_disp(:,:,1) =
0.5*abs(rect_diag_samp_signal_fd)/
max2(rect_diag_samp_signal_fd);
image_disp(:,:,2) = image_disp(:,:,1);
image_disp(:,:,3) = image_disp(:,:,1);
image(image_disp);
title_{—} = [‘Diagonal Rectangular Sampling, Sample Spacing = 10 mm,
Angle
= arctan(3/4), Max Signal Freq = ‘,num2str(r/500),’ cycles/mm’];
Title(title_)
xlabel(‘Frequency (cycles/mm * 500 offset by 250)’)
file_{—} = [‘diag_rect_fd_’,num2str(r)];
print(‘-djpeg’,file_);
figure(4)
image_disp(:,:,1) = 0.5*array/max2(array);
image_disp(:,:,2) = image_disp(:,:,1);
image_disp(:,:,3) = image_disp(:,:,1);
image(image_disp)
Title(‘Original Signal in the Frequency Domain’)
xlabel(‘Frequency (cycles/mm * 500 offset by 250)’)
file_{—} = [‘signal_fd_’,num2str(r)];
print(‘-djpeg’,file_);
figure(5)
image_disp(:,:,1) = abs(rect)/max2(rect);
image_disp(:,:,2) = image_disp(:,:,1);
image_disp(:,:,3) = image_disp(:,:,1);
image(image_disp);
title_{—} = [‘Rectangular Sampling Grid, Sample Spacing = 10 mm ’];
Title(title_)
xlabel(‘Position (mm)’)
file_{—} = [‘rect_grid’];
print(‘-djpeg’,file_);
figure(6)
image_disp(:,:,1) = abs(hex)/max2(hex);
image_disp(:,:,2) = image_disp(:,:,1);
image_disp(:,:,3) = image_disp(:,:,1);
image(image_disp);
title_{—} = [‘Hexagonal Sampling, Sample Spacing = 10 mm’];
Title(title_)
xlabel(‘Position (mm)’)
file_{—} = [‘hex_grid’];
print(‘-djpeg’,file_);
figure(7)
image_disp(:,:,1) = abs(diags_rect)/max2(diags_rect);
image_disp(:,:,2) = image_disp(:,:,1);
image_disp(:,:,3) = image_disp(:,:,1);
image(image_disp);
title_{—} = [‘Diagonal Rectangular Sampling, Sample Spacing = 10 mm,
Angle
= arctan(3/4)’];
Title(title_)
xlabel(‘Position (mm)’)
file_{—} = [‘diag_rect_grid’];
print(‘-djpeg’,file_);
A2 Program dones.m
y = [0:r];
x = r−y;
k = length(x);
y = [−y(k:−1:2) y];
x = [x(k:−1:2) x];
y = y+centy;
x = round(x);
for k=1:length(y)

if x(k) ˜= 0

array([centx−x(k):centx+x(k)],y(k)) = ones(2*x(k)+1,1);

end

end

What is claimed is:

1. A method for better matching the configuration of the spatial resolution pattern of an image sensor, the method comprising:
determining a desired rotation angle of the spectrum of a two dimensional signal; and
rotating the sampling grid relative to the sampling area by the rotation angle.

2. The method of claim 1 in which the sampling grid forms a rectangular pattern.

3. The method of claim 2 in which the rotation angle is 45 degrees.

4. The method of claim 2 in which the rotation angle is arctan(¾).

5. The method of claim 2 in which the rotation angle is arctan(4/3).

6. The method of claim 1 in which the sampling grid forms a hexagonal pattern.

7. The method of claim 6 in which the angle of rotation is 15 degrees.

8. The method of claim 6 in which the angle of rotation is 45 degrees.

9. A method comprising organizing a sensor to sample data with greater frequency response according to nature.

10. The method of claim 9 wherein according to nature includes providing the sensor with a greater frequency response in a horizontal and vertical dimension.

11. The method of claim 9 wherein the sensor is organized with a diagonal sensor pattern to provide the greater frequency response accor

12. A digital signal processor organized to perform the method of claim 1
